(19) United States
(12) Patent Application Publication
(10) Pub. No.: US 2012/0246254 A1
(43) Pub. Date: Sep. 27, 2012

(54) Method and Apparatus for User Equipment Accessing in IP Multimedia Subsystem

(75) Inventors: Zhifeng Chen, Shenzhen (CN); Zhenwu Hao, Shenzhen (CN)

(73) Assignee: ZTE CORPORATION, Shenzhen City, Guangdong Province (CN)

(21) Appl. No.: 13/513,169

(22) PCT Filed: Apr. 12, 2010
(86) PCT No.: PCT/CN10/71703

§ 371 Date: May 31, 2012

(30) Foreign Application Priority Data
Dec. 1, 2009 (CN) 200910204576.9

(51) Int. Cl. G06F 15/16

(52) U.S. Cl. 709/206; 709/226

(57) ABSTRACT

A method and an apparatus for UE accessing an IP Multimedia Subsystem (IMS) are disclosed in the present invention. The method includes: setting a user equipment access apparatus (308) at user equipment (301) side; when the user equipment (301) establishes a session with a peer network element through an IMS core network, the IMS core network (309) instructing the user equipment access apparatus (308) to reserve media plane forwarding resource, and the user equipment access apparatus (308) allocating the media plane forwarding resource to the user equipment (301); during a session between the user equipment (301) and the peer network element, said user equipment access apparatus (308) forwarding media plane information between the user equipment (301) and the peer network element according to the media plane forwarding resource. The apparatus provided in the present invention can be deployed flexibly.

### TECHNICAL FIELD

The present invention relates to the field of communications, and more especially, to a method and apparatus for user equipment accessing in an IP Multimedia Subsystem.

### BACKGROUND OF THE RELATED ART

IP Multimedia Subsystem (IMS) is a standard of the next generation network defined by the 3^{rd} Generation Partnership Project (referred to as 3GPP), its notable features are that it uses the Session Initiation Protocol (SIP) system, the communication is separated from the access, and it has the capabilities such as separating the multi-media service control function from the bearer capacity, separating the call from the session, separating the applications from the services, separating the services from the networks, and integrating services of the mobile network with the services of the Internet, and so on, the proposal of the IMS conforms to the trend of the integration of communication networks in the development.

The main function entities in the IMS system comprise: the Call Session Control Function (referred to as CSCF) that provides functions such as the user registration management and the session control, the Home Subscriber Server (HSS) that provides the function of centralized management of user subscription data, and the application server (AS) that provides a variety of service logic control functions.

FIG. 1 describes the network element entities in the IMS architecture that are related to the present invention as well as their relations. Among them: the user equipment (referred to as UE) 101 represents the terminal equipment used by the users, the call session control function (CSCF) is the core network element controlling the session, including: the Proxy-CSCF (P-CSCF) 102, the Interrogating-CSCF (I-CSCF), and the Serving-CSCF (S-CSCF) 103; the Home Subscriber Server (HSS) is the primary storage server of all the user and server related data in the IMS; the Application Server (AS) 104 is a network element providing value-added multimedia services; the access gateway (AGW) 105 provides the user equipment with helps such as the Network Address Translators (NAT) for the user equipment to access the IMS network, and facilitates the operation and management at the same time, the P-CSCF uses the Iq interface to control the AGW.

FIG. 2 is a diagram illustrating a process of a user establishing a session via the AGW, and the process is described as follows:

step 201, when the UE A attempts to call another user equipment UE B, UE A sends a SDP provision message to the P-CSCF to which it registers, and the message carries the media plane contact address (c=A) that the UE B uses for this session;

step 202, after the P-CSCF receives the SDP provision message, it sends a reservation request message to a selected access gateway to allocate resources to the receiving address of the UE A in this session;

step 203, after the access gateway successfully completes the resource allocation, it returns the allocation result (c=Tr_A) to the P-CSCF;

step 204, after the P-CSCF replaces the session media plane contact address with the address (c=Tr_A) allocated by the Access Gateway in the SDP provision message, the P-CSCF sends the SDP provision message to the S-CSCF;

step 205, the S-CSCF forwards the SDP provision message to the peer UE B, the P-CSCF which may be passed through for the UE B is omitted in this step;

step 206, the UE B receives the SDP provision message, deals with it accordingly, and returns a SDP response message to the S-CSCF, wherein, the SDP response message carries the media plane contact address (c=B) used by the UE B for this session;

step 207, the S-CSCF forwards the SDP response message returned by the UE B to the P-CSCF;

step 208, similar to the step 202, the P-CSCF allocates resources to the receiving address of the UE B in the session at the selected access gateway, herein, the selected access gateway might be not the same as the one in step 202, but for more concisely representing the process, the same access gateway is used here;

step 209, the access gateway successfully completes the resource allocation, and returns the allocation result (c=Tr_B) to the P-CSCF; step 210, the P-CSCF replaces the media plane contact address of the UE B in the SDP response message with the information (c=Tr_B) returned by the access gateway and sends it to the UE A;

step 211, to this point, the negotiation of this session is completed, and a media session is established between the UE A and the UE B through the access gateway.

The 3GPP organization specifies that the Iq interface uses the H.248 protocol, and since the H.248 itself does not provide reliable security mechanisms, the access gateway can only be deployed in a proprietary network provided by the trusted operator. When a user lands from a place which is far away from the proprietary network, for example, a user logs on from the Internet to the IMS domain, due to the long distance between the user and the access gateway, it is relatively difficult to guarantee the quality of the network between the user and the access gateway, which is not conducive to the service development.

### SUMMARY OF THE INVENTION

The technical problem to be solved in the present invention is to provide a method and apparatus for user equipment accessing to an IP Multimedia Subsystem, to reduce the distance between the user equipment and the access apparatus.

In order to solve the aforementioned technical problem, the present invention provides a method for user equipment accessing in an IP Multimedia Subsystem, comprising:

setting a user equipment access apparatus at user equipment side;

when the user equipment establishes a session with a peer network element through an IMS core network, the IMS core network instructing the user equipment access apparatus to reserve media plane forwarding resource, and the user equipment access apparatus allocating the media plane forwarding resource to the user equipment; and

during a session between the user equipment and the peer network element, said user equipment access apparatus forwarding media plane information between the user equipment and the peer network element according to the media plane forwarding resource.

The aforementioned method might also have the following feature:

after the step of setting the user equipment access apparatus at the user equipment side, the method also comprises:

the user equipment access apparatus signing a contract with an IMS operator, registering to the IMS core network, and setting up a trust relationship between the user equipment access apparatus and the IMS core network.

The aforementioned method might also have the following feature:

in the step of registering, the user equipment access apparatus informing the IMS core network that the user equipment access apparatus is an access apparatus through apparatus authentication information; or, the user equipment access apparatus informing the IMS core network that the user equipment access apparatus is an access apparatus by adding an identifier and/or writing apparatus ability in a message interacted with the IMS core network.

The aforementioned method might also have the following feature:

the step of the IMS core network instructing the user equipment access apparatus to reserve the media plane forwarding resources comprises:

after an application server (AS) in the IMS core network receives a session request message or a session response message sent by the user equipment, the AS judging whether the user equipment access apparatus is needed to perform session transfer or not, if yes, instructing the user equipment access apparatus to reserve the media plane forwarding resources through a call session control function (CSCF);

after the user equipment access apparatus allocates the media plane forwarding resources to the user equipment, the method also comprises:

returning a reservation result to the AS through the CSCF; and

the AS replacing a media plane contact address in the message received from the user equipment according to the reservation result, and forwarding the message to a peer network element through the CSCF.

The aforementioned method might also have the following feature:

the step of the IMS core network instructing the user equipment access apparatus to reserve the media plane forwarding resources comprises:

after the CSCF in the IMS core network receives a session request message or a session response message sent by the user equipment, the CSCF judging whether needs the user equipment access apparatus to perform session transfer or not, and if yes, the CSCF instructing the user equipment access apparatus to reserve the media plane forwarding resource;

after the user equipment access apparatus allocates the media plane forwarding resource to the user equipment, the method also comprises:

returning a reservation result back to the CSCF; and

the CSCF replacing the media plane contact address in the message received from the user equipment according to the reservation result, and then forwarding the message to a peer network element through the CSCF.

The aforementioned method might also have the following feature:

in the step of instructing, the AS instructing the user equipment access apparatus to reserve the media plane forwarding resources by forwarding the received session request message or session response messages sent by the user equipment to the user equipment access apparatus;

in the step of returning the reservation result, the user equipment access apparatus returning the reservation result to the AS by replacing the media plane contact address in the received session request message or session response message;

or,

in the step of instructing, the AS instructing the user equipment access apparatus to reserve the media plane forwarding resources by newly creating a session request message and sending the session request message to the user equipment access apparatus;

in the step of returning the reservation result, the user equipment access apparatus returning the reservation result back to the IMS core network by returning the session response message to the AS.

The aforementioned method might also have the following feature:

in the step of instructing, the CSCF instructing the user equipment access apparatus to reserve the media plane forwarding resources by forwarding the received session request message or session response messages to the user equipment access apparatus;

in the step of returning the reservation result, the user equipment access apparatus returning the reservation result to the CSCF by replacing the media plane contact address in the received session request message or session response message.

In order to solve the aforementioned technical problem, the present invention provides a user equipment access apparatus in an IP multimedia subsystem, and the apparatus is located at the user equipment side, comprising a communication module, a control module and a gateway module, wherein,

the communication module is set to: communicate with an IP multimedia subsystem (IMS) core network, inform the control module when receiving an instruction from the IMS core network for reserving media plane forwarding resource; and send a reservation result returned by the control module to the IMS core network;

said control module is set to: control and manage the communication module and the gateway module, and control the gateway module to allocate media plane forwarding resource when acquiring through the communication module the instruction from the IMS core network for reserving the media plane forwarding resource, receive and return the reservation result sent by the gateway module back to the communication module;

said gateway module is set to allocate the media plane forwarding resource to the user equipment under control of the control module, and inform the control module of the reservation result of the media plane forwarding resource, as well as during a session between the user equipment and a peer network element, forward media plane information between the user equipment and the peer network element according to the media plane forwarding resource.

The aforementioned apparatus might also have the following feature:

the control module is also set to register to the IMS core network via the communication module after the user equipment access apparatus signs a contract with an IMS operator, and establish a trust relationship between the user equipment access apparatus and the IMS core network.

The aforementioned apparatus might also have the following feature:

the communication module is set to inform the control module after the communication module receives the session request message or the session response messages forwarded by the IMS core network; and send a message returned by the control module to the IMS core network;

said control module is set to control the gateway module to allocate the media plane forwarding resource according to the session request message or the session response message, and, after receiving the reservation result sent by the gateway module, replace a media plane contact address in the received message according to the reservation result, and return the message back to the communication module.

The aforementioned apparatus might also have the following feature:

the communication module is set to inform the control module after receiving a session request message newly established by the IMS core network; and, send a session response message returned by the control module to the IMS core network;

said control module is set to control the gateway module to allocate the media plane forwarding resource according to the newly established session request message, and, after receiving the reservation result sent by the gateway module, generate a session response message according to the reservation result, and return to the communication module.

The apparatus provided in the present invention can be deployed flexibly, and the apparatus is not limited to be deployed within the IMS core network, but can be deployed at any location in the network. Moreover, since the apparatus has functions such as registration and cancellation, adding or removing an apparatus does not need to configure other apparatuses within the core network, thereby allowing for relatively frequent adjustment; if the network has multiple of these apparatuses, all of the apparatuses are expected to be opened before the arrival of the peak of the traffic, and part of the apparatuses are shut down after the peak of the traffic, so as to achieve energy saving efficacy.

### BRIEF DESCRIPTION OF DRAWINGS

FIG. 1 is a schematic diagram of an IMS network architecture in the related art.

FIG. 2 is a flow diagram of establishing a media session via the AGW in the related art.

FIG. 3 is a schematic diagram of the network basic architecture in accordance with an embodiment of the present invention.

FIG. 4 is a diagram of a registration process of the user equipment access apparatus in accordance with an embodiment of the present invention.

FIG. 5A and FIG. 5B are diagrams of a session establishment process in accordance with an embodiment of the present invention.

FIG. 6 is a flow diagram of session release in accordance with an embodiment of the present invention.

FIG. 7 is a diagram of another session establishment process in accordance with an embodiment of the present invention.

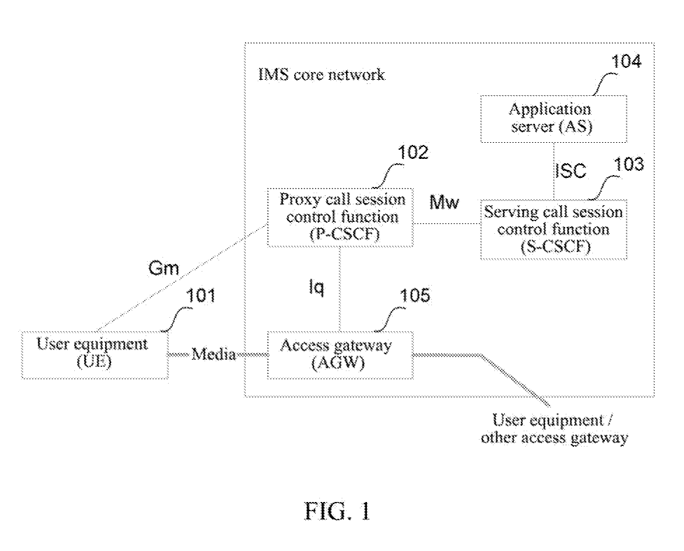

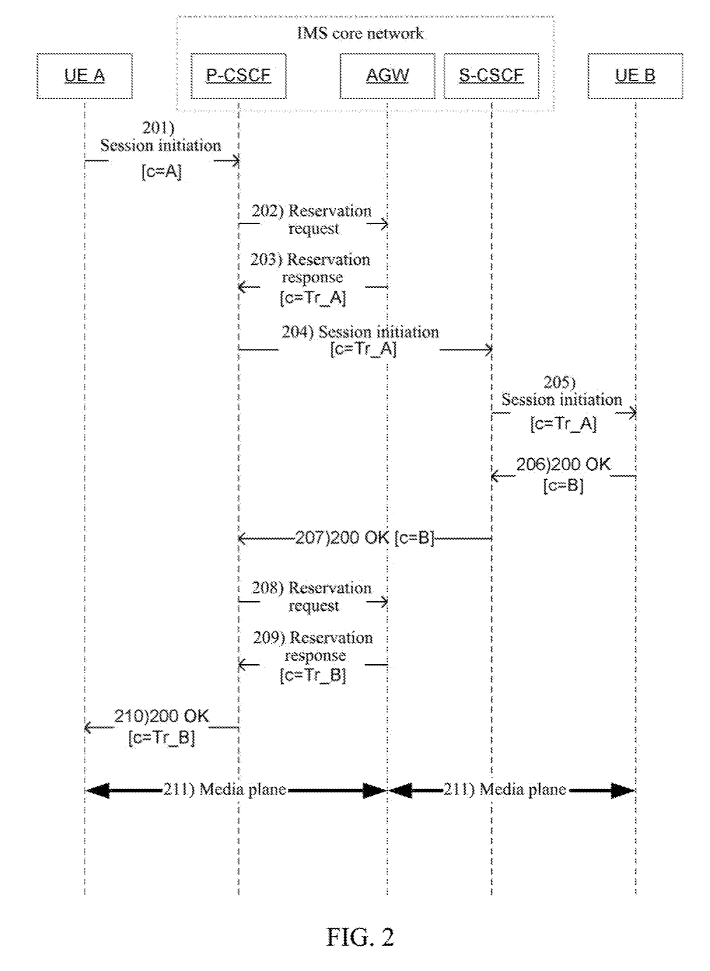

### PREFERRED EMBODIMENTS OF THE PRESENT INVENTION

The present invention provides a user equipment access apparatus (hereinafter also referred to as the apparatus or access apparatus) that is not limited to be deployed within the private network but can be deployed quite flexibly, thereby reducing the distance between the user and the access apparatus.

The apparatus is located at the user side, and communicates with the IMS core network via the Gm interface, and provides the media plane information forwarding between the user equipments and user equipments as well as the other media plane gateway apparatuses.

Specifically, the user equipment access method in accordance with the embodiment of the present invention comprises:

setting a user equipment access apparatus at user equipment side;

when the user equipment establishes a session with a peer network element through an IMS core network, the IMS core network instructing the user equipment access apparatus to reserve media plane forwarding resource, and the user equipment access apparatus allocating the media plane forwarding resource to the user equipment;

during a session between the user equipment and the peer network element, said user equipment access apparatus forwarding media plane information between the user equipment and the peer network element according to the media plane forwarding resource.

The apparatus has basic functions such as registration, cancellation, registration refresh in the IMS network, after the apparatus signs a contract with the IMS operator, it can register to the IMS core network so as to establish a trust relationship between the user equipment access apparatus and the IMS core network.

During the registration process, the apparatus informs the IMS core network with the following two methods, of that the apparatus is the access apparatus rather than common user equipment:

(1) through the specific apparatus authentication information, such as the Public User Identity (PUI) or the Private User Identity (PVI), and so on;

(2) by adding an identifier or writing apparatus ability in the message interacted with the IMS core network.

The apparatus has the resource reservation capability in the establishment process of IMS session, and the basic process comprises the following steps.

A, after the IMS core network receives the session request message or the session response message sent by the user equipment, it judges whether the user equipment access apparatus is needed to perform session transfer or not, and if yes, instructs the access apparatus to reserve the media plane forwarding resource.

B, the access apparatus allocates the media plane forwarding resources to the user equipment, and returns the reservation result back to the IMS core network.

C, the IMS core network replaces the media plane contact address in the message received from the user equipment according to the reservation result, and then forwards the message to the peer network element.

Wherein, the access apparatus allocating the media plane forwarding resources to the user equipment specifically refers to: the access apparatus allocates a media plane contact address to this session of the user equipment.

Said IMS core network judges whether it needs the user equipment access apparatus to perform session transfer or not, and the network element that replaces the media plane contact address in the message received from the user equipment according to the reservation result is the AS, or the CSCF, and when it is the AS,

in step A, after the AS receives the session request message or the session response message sent by the user equipment, it forwards the received message to the access apparatus to instruct the access apparatus to reserve the media plane forwarding resource; furthermore, in step B, the access apparatus sends the reservation result to the AS by replacing the media plane contact address in the message;

alternatively, in the step A, after the IMS core network receives the session request message or the session response message sent by the user equipment, it can instruct the access apparatus to reserve the media plane forwarding resources by newly creating a session request message and sending the message to the access apparatus, and; furthermore, in the step B, the access apparatus sends the reservation result to the IMS core network by returning the session response message to the IMS core network.

That is, when the IMS core network forwards the request and the response messages to the apparatus in the present invention, when the apparatus in the present invention returns the reservation result in step B, it also forwards the messages to the IMS core network by replacing the media plane information in the request and response messages.

When the IMS core network uses the newly established request message to the apparatus in the present invention, the apparatus in the present invention returns the reservation result in the step B, and carries the reservation result in the newly created response message and sends it to the IMS core network.

When the CSCF judges whether it needs the user equipment access apparatus to perform session transfer or not, as well as replaces the media plane contact address in the message received from the user equipment with the reservation result, in the step A, after the CSCF receives the session request message or the session response message sent by the user equipment, the CSCF may instruct the access apparatus to reserve the media plane forwarding resources by forwarding the received message to the access apparatus; furthermore, in the step B, the access apparatus sends the reservation result to the CSCF by replacing the media plane contact address in the message.

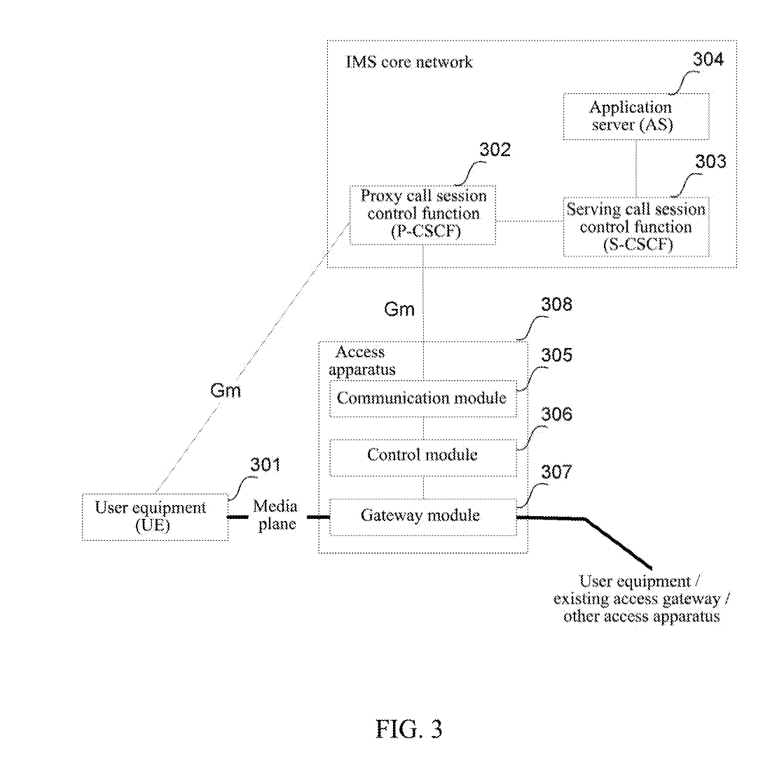

FIG. 3 is a schematic diagram of the network basic architecture in accordance with an embodiment of the present invention, the apparatus in the present invention is called the access apparatus 308, and the apparatus is associated with the P-CSCF302 in the IMS core network via the Gm interface, the P-CSCF302 is associated with the S-CSCF303, the S-CSCF303 and the AS304. The access apparatus 308 can forward the media plane information between the user equipment 301, the other access apparatuses, or the existing access gateways.

The apparatus comprises the following function entities: the communication module 305 that is responsible for communicating with the IMS core network, its main function is to communicate with the IMS domain through the Gm interface; the gateway module 307 that is mainly responsible for forwarding the media plane information, and it is mainly responsible for forwarding the media plane data from the user equipment to other user equipment or the media plane data gateway apparatus such as another user equipment access apparatus; the control module 306 that is responsible for controlling and managing the access apparatus.

Specifically, the communication module 305 is used to communicate with the IMS core network, and inform the control module 306 when receiving the instruction from the IMS core network for reserving the media plane forwarding resource; and, send the reservation result returned by the control module 306 to the IMS core network;

said control module 306 is used to control and manage the communication module 305 and the gateway module 307, when it acquires the instruction from the IMS core network for reserving the media plane forwarding resource via the communication module 305, control the gateway module 307 to allocate the media plane forwarding resource, and receive the reservation result sent by the gateway module 307 and send it back to the communication module 305;

the gateway module 307 is used to allocate the media plane forwarding resource to the user equipment 301 according to the control by the control module 306, and inform the control module 306 of the reservation result of the media plane forwarding resource, and, in the session between said user equipment 301 and the peer network element, forward the media plane information between the user equipment 301 and the peer network element according to the media plane forwarding resource.

Among them, the control module 306 and the gateway module 307 can be deployed in the same physical apparatus or different physical apparatuses; moreover, in one access apparatus, there might be one or more of the control modules 306, as well as one or more of the gateway modules 307.

The control module 306 is further used to register to the IMS core network via the communication module 305 after the access apparatus signs a contract with the IMS operator, and establish a trust relationship between the access apparatus and the IMS core network.

Preferably, the control module 306 further informs the IMS core network that it is an access apparatus in the registration process through the apparatus authentication information; or, informs the IMS core network that it is an access apparatus by adding an identifier and/or writing apparatus ability in the message interacted with the IMS core network.

Preferably, the communication module 305 is further used to inform the control module 306 after receiving the session request message or the session response messages forwarded by the IMS core network; and send the message returned by the control module 306 to the IMS core network; the control module 306 is further used to control the gateway module 307 to allocate the media plane forwarding resources according to the session request message or the session response message, and after receiving the reservation result sent from the gateway module 307, replace the media plane contact address in the received message according to the reservation result, and return the message back to the communication module 305.

Preferably, the communication module 305 is further used to inform the control module 306 after receiving the session request message newly established by the IMS core network; and, send the session response message returned by the control module 306 to the IMS core network; said control module 306 is further used to control the gateway module 307 to allocate the media plane forwarding resources according to the newly established session request message, and, after receiving the reservation result sent by the gateway module 307, generate a session response message according to the reservation result, and return the message back to the communication module 305.

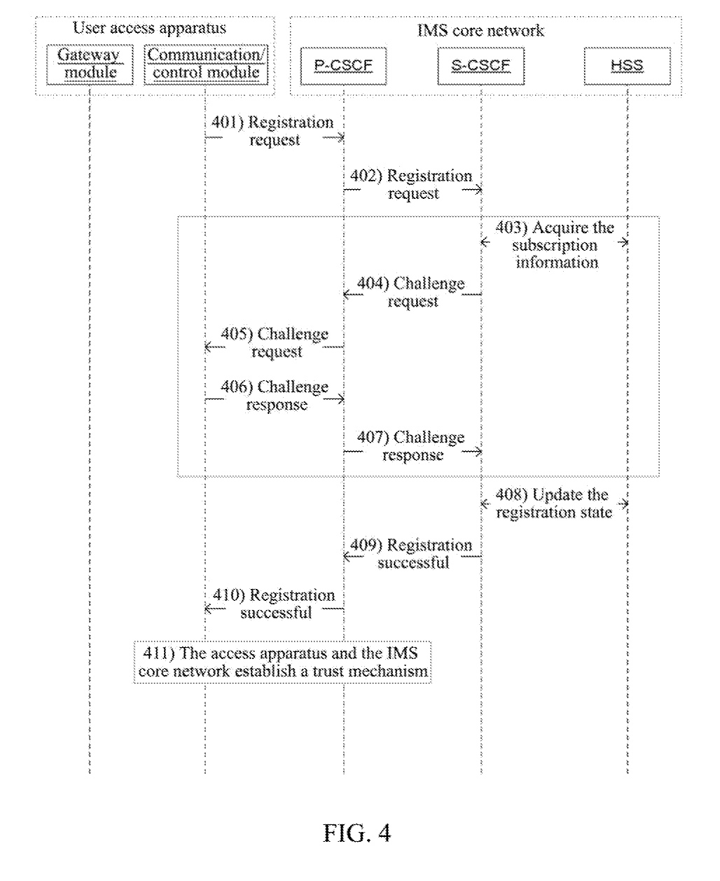

After the access apparatus signs the contract with the IMS operator, the HSS in the IMS core network has the subscription information (including information such as PUI, PVI) of the user corresponding to the access apparatus. FIG. 4 is a diagram of the access apparatus, which is provided in the present invention and has signed a contract with the IMS operator, registering to the IMS network, and the description of the specific process is as follows.

In step 401, after the access apparatus is turned on and the hardware and software of the apparatus are initialized, the control module initiates and sends a registration request message to the appropriate P-CSCF via the communication module, and the registration request message comprises the public user identity and private user identity.

In step 402, the P-CSCF forwards the registration request message to the designated S-CSCF. This process might need the I-CSCF network element to locate, since it is unrelated to the related processes of the present invention, it will be omitted from the description.

In step 403, when the state of the apparatus is not the state of Not Registered, directly jump to step 408, otherwise the S-CSCF acquires the subscription information corresponding to the access apparatus as well as authentication information such as the authentication quintuple from the HSS.

In step 404, the S-CSCF sends a challenge request to the apparatus.

In step 405, the P-CSCF forwards the challenge request to the access apparatus.

In step 406, similar to a common terminal equipment, the access apparatus generates a challenge response after accordingly processing the challenge request, and sends the response to the P-CSCF.

In step 407, the P-CSCF forwards the challenge response to the S-CSCF.

In step 408, the S-CSCF notifies the HSS to update the registration status of the user corresponding to the apparatus.

In step 409, after the S-CSCF completes the registration of the access apparatus, the S-CSCF returns a registration successful message to the P-CSCF.

In step 410, the P-CSCF forwards the registration successful message to the access apparatus.

In step 411, to this point, the registration process of the access apparatus is completed, thereby a trust mechanism is established between the access apparatus and the P-CSCF (that is, the IMS core network).

The IMS network can determine that this registration is from a user equipment access apparatus rather than a common terminal apparatus according to the authentication information (including the PUI, PVI, and so on) provided by the access apparatus, also, the user equipment access apparatus may be distinguished from the common terminal equipment by an identifier added to or the apparatus ability written into the registration message.

Same as the general terminal equipment, the cancellation process of the access apparatus is the same as the registration process, and the only difference is that the time-out is set as 0.

After the access apparatus completes the registration successfully, the corresponding services can be carried out, during a session, since the apparatus as well as the user equipment has no direct relationship with other network elements except of the P-CSCF in the IMS core network, the interactive process in the IMS core network is not associated with the present invention, therefore, the IMS core network in the subsequent embodiments is taken as a whole, but the access apparatus and the user equipment are still only directly associated with the P-CSCF.

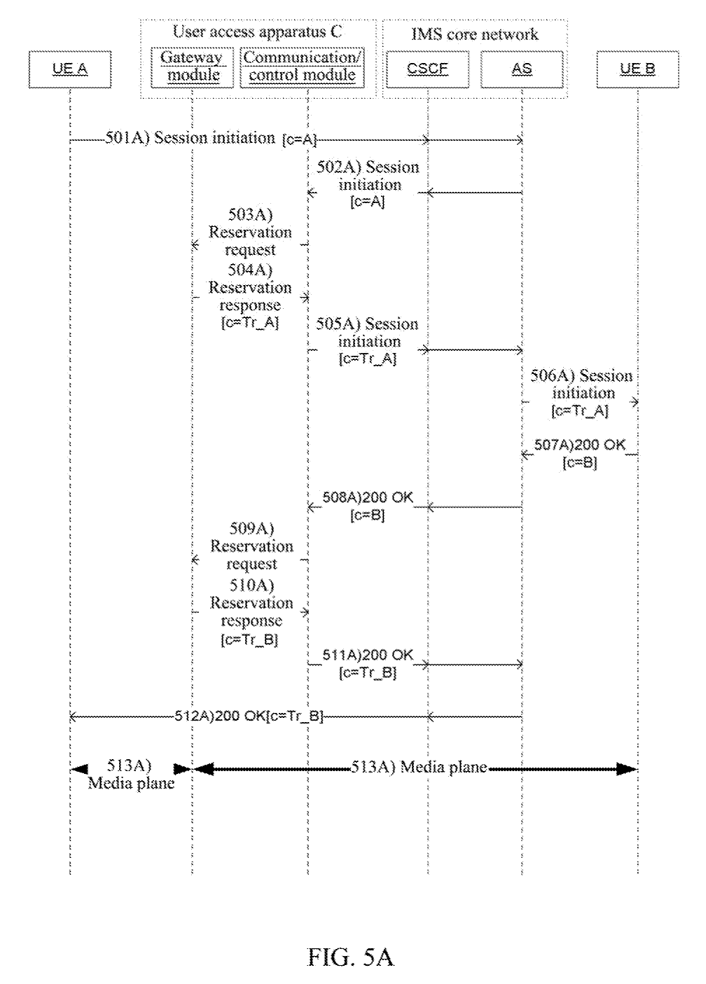

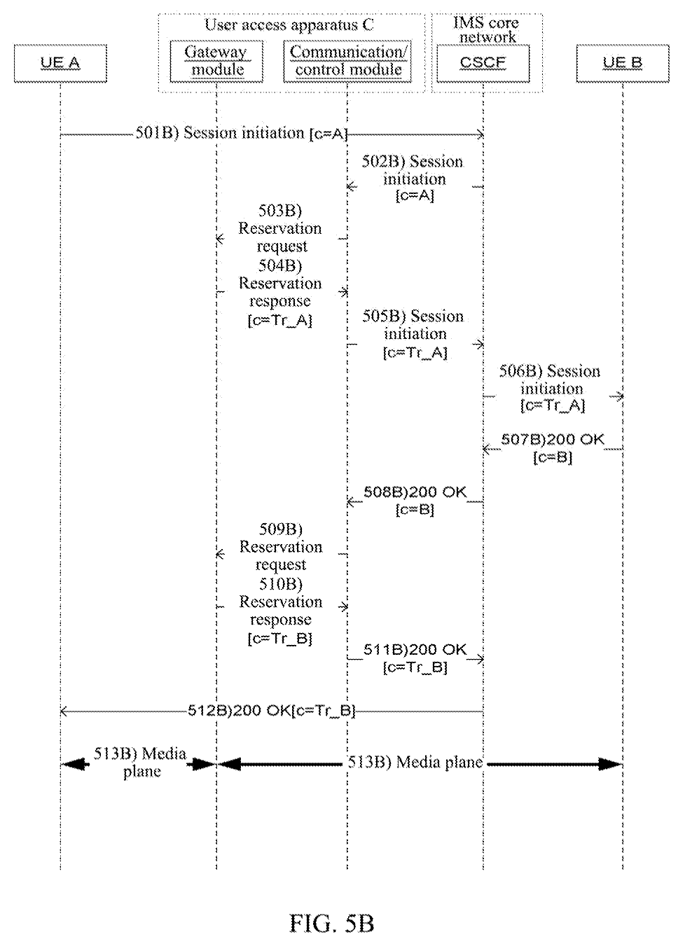

FIG. 5A and FIG. 5B are diagrams of the session establishment process in accordance with an embodiment of the present invention, and they mainly describe the process of the two user equipments UE A and UE B establishing a session in which the media is forwarded via the access apparatus. The specific process is as follows.

In step 501A, the UE A calls the UE B, and sends a session initiation message (that is, a session request message, usually the INVITE message) carrying the SDP provision information to the peer end through the IMS core network, wherein, the SDP provision information comprises the media plane contact address c=A of this session; the message reaches to the CSCF network element in the IMS core network, and is forwarded by the CSCF to the application server (AS).

In step 502A, the AS determines that the session needs to be forwarded by the access apparatus C in order to better provide this session with services, therefore, the control module in the access apparatus C is requested to reserve resources by sending a session initiation message to the control module, and the initiation message also needs to be forwarded through the CSCF.

In step 503A, after the control module in the access apparatus C receives the SDP provision information, the control module sends a resource reservation request to the gateway module.

In step 504A, after the gateway module completes the resource reservation, the gateway module returns the resource reservation result c=Tr_A, and at the same time, stores the correspondence between the reservation result Tr_A and the original media plane contact address A.

In step 505A, the access apparatus C forwards the reservation result c=Tr_A to the IMS core network, and the result reaches the application server after forwarded by the CSCF.

In step 506A, the AS sends a session initiation message carrying the SDP provision information to the peer UE B, wherein, the media plane contact address of the UE A is c=Tr_A.

In step 507A, the UE B returns a SDP response (the response is forwarded by the CSCF) to the application server, wherein, the media plane contact address of the UE B contained in the response is c=B.

In step 508A, similar to the step 502A, the application server requires the control module in the access apparatus C to perform resource reservation by sending the SDP response information to the control module (similarly through the CSCF), wherein, another access apparatus can be selected as the application server, and the access apparatus C is selected here only in order to facilitate the description. In step 509A, after the control module in the access apparatus C receives the SDP response information, the control module sends a resource reservation request to the gateway module.

In step 510A, similar to the step 504A, after the gateway module completes the resource reservation, it returns the resource reservation result c=Tr_B and records the correspondence between the Tr_B and the B.

In step 511A, the access apparatus C returns the reservation result c=Tr_B back to the IMS core network, and the result reaches to the application server through the CSCF.

In step 512A, the application server sends the SDP response information to the terminal UE A via the CSCF, wherein, the UE B's media face contact address is c=Tr_B.

In step 513A, to this point, the UE A and the UE B complete the SDP negotiation of the session, and the media link forwarded through the access apparatus C can be established according to the negotiation result, thus the media session is performed.

In the media session, the UE A and the UE B respectively listen to the media plane packets at the addresses c=A and c=B, while the gateway module in the access apparatus C listens to the media plane packets at the two addresses c=Tr_A and c=Tr_B; the UE A sends the media plane packets sent to the UE B to the c=Tr_B, the gateway module forwards the packets to the c=B listened by the UE B according to the correspondence stored during the reservation; similarly, the gateway module also forwards the message sent by the UE B at the c=Tr_A to the UE A, and delivers the message to the c=A listened by the UE A, thereby achieving the media session between the UE A and the UE B.

The session initiation message might carry the SDP information or not, but generally the SDP information is carried in the session initiation message, and the session initiation message carrying the SDP information is taken for example in the present invention.

In the step 502A of FIG. 5A, the basis for the application server (AS) in the IMS core network judging whether the session established in this example needs to be forwarded through the access apparatus C or not might be but are not limited to all or part of the following information: the operator's policy information, the subscriptions information of the two parties in the session, the user setting of the two parties in the session, the topology information of the network in which both the apparatuses in the session are located, as well as the current access information of the two apparatuses in the session.

FIG. 5A is a diagram of the network element application server (AS) in the IMS core network completing the following functions: judging whether the access apparatus is needed to forward or not, when the access apparatus is needed, resources should be reserved, meanwhile, the media plane address in the signal is replaced according to the reservation result. In practical applications, the network element call session control function (CSCF) may also be used to accomplish the above functions, and the specific process is shown in FIG. 5B, which is described as follows:

In step 501B, the UE A calls the UE B, and sends a session initiation message (that is, the session request message, usually the INVITE message) carrying the SDP provision information to the peer end through the IMS core network, and the message contains the media plane contact address c=A of this session.

In step 502B, the message reaches to the network element CSCF in the IMS core network, and the CSCF determines that the session should be forwarded by the access apparatus C in order to better provide services to this session, therefore, the control module in the access apparatus C is required to reserve the resources by sending the session initiation message to the control module. If the CSCF performing the judgment and reservation is the S-CSCF, the initiation message might need to be forwarded by the P-CSCF, if the CSCF performing the judgment and reservation is the P-CSCF, the initiation message is directly sent to the access apparatus C.

In step 503B, after the control module in the access apparatus C receives the SDP provision information, it sends a resource reservation request to the gateway module.

In step 504B, after the gateway module completes the resource reservation, it returns the resource reservation results c=Tr_A, and stores the correspondence between the reservation result Tr_A and the original media plane contact address A.

In step 505B, the access apparatus C forwards the reservation result c=Tr_A to the IMS core network, and the result reaches to the CSCF.

In step 506B, the CSCF sends the session initiation message carrying the SDP provision information to the peer UE B, wherein, the media plane contact address of the UE A is c=Tr_A.

In step 507B, the UE B returns the SDP response to the CSCF, wherein, the media plane contact address of the UE B contained in the response is c=B.

In step 508B, similar to the step 502B, the application server requires the control module (similarly through the CSCF) in the access apparatus C to reserve the resources by sending the SDP response information to the control module in the access apparatus C, the CSCF might also be selected as another access apparatus, and the access apparatus C is selected here only in order to facilitate the description,

In step 509B, after the control module in the access apparatus C receives the SDP response information, the control module sends a resource reservation request to the gateway module.

In step 510B, similar to the step 504B, after the gateway module completes the resource reservation, the gateway module returns the resource reservation result c=Tr_B and records the correspondence between the Tr_B and the B.

In step 511B, the access apparatus C returns the reservation result c=Tr_B to the CSCF.

In step 512B, the CSCF sends the SDP response information to the terminal UE A, wherein, the media plane contact address of the UE B is c=Tr_B.

In step 513 B, to this point, the UE A and the UE B completes the SDP negotiation of the session, and the media link forwarded through the access apparatus C is established according to the negotiation result, and the media session is performed.

Of course, besides that the two network elements AS and CSCF shown in the above FIG. 5A and FIG. 5B implement the previously described judgment, the reservation control, and the SDP update, and other functions, other network elements in the core network can also be used, but in essence, the judgment in all the cases is performed by the IMS core network, and the processes are very similar.

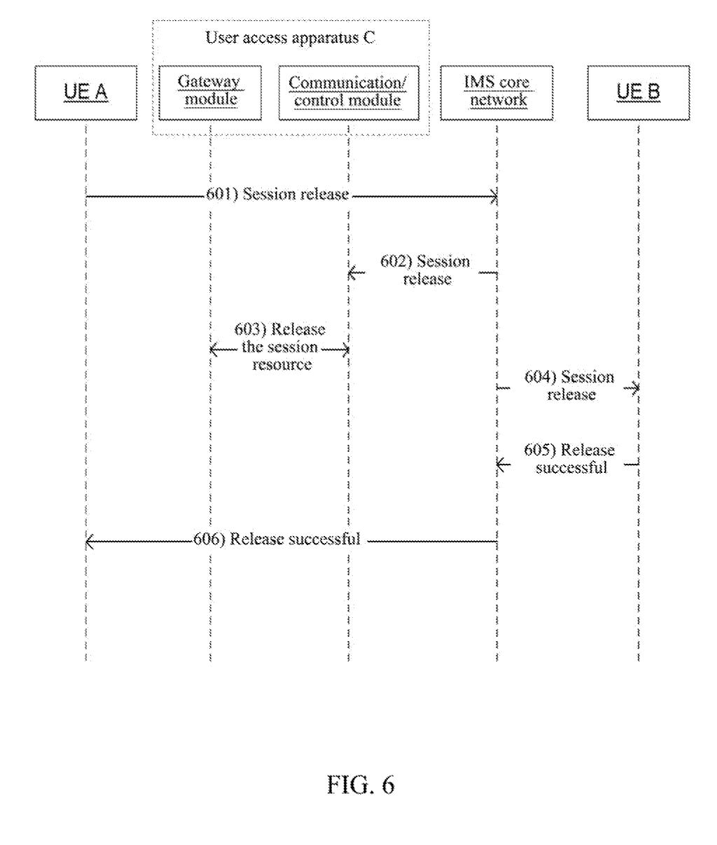

FIG. 6 is a flow diagram of session release in accordance with an embodiment of the present invention, and the specific process is described as follows.

In step 601, the UE A hangs up the session actively, and sends a session release request to the IMS core network.

In step 602, the IMS core network determines that it needs to release the resources allocated to the access apparatus C, so it sends a session release request message to the access apparatus C through the Gm interface.

In step 603, after the control module in the access apparatus C receives the request message, it releases the resources allocated to the session.

In step 604, at the same time when the IMS core network sends a session release request message to the access apparatus C, the IMS core network also forwards the session release request sent from the UE A to the peer UE B.

In step 605, after the UE B completes the release operation, it returns a release successful response message to the IMS core network.

In step 606, after the IMS core network returns the release successful response message to the UE A, the session release process completes.

In the process shown in FIG. 5, the access apparatus achieves the forwarding of the session initiation and response messages, the media resources are reserved in the processes of forwarding and processing, and the media plane address in the session initiation or response message is replaced according to the reservation result, the entire session establishment process only needs a session to complete. However, this process needs the IMS core network to forward the session initiation and response messages to the user access apparatus, which has some special requirements on the IMS core network, taking this into account, the apparatus provided in the present invention also provides the support to establish a session with 3pcc (Third Party Call Control), instead of having special requirements on the IMS core network.

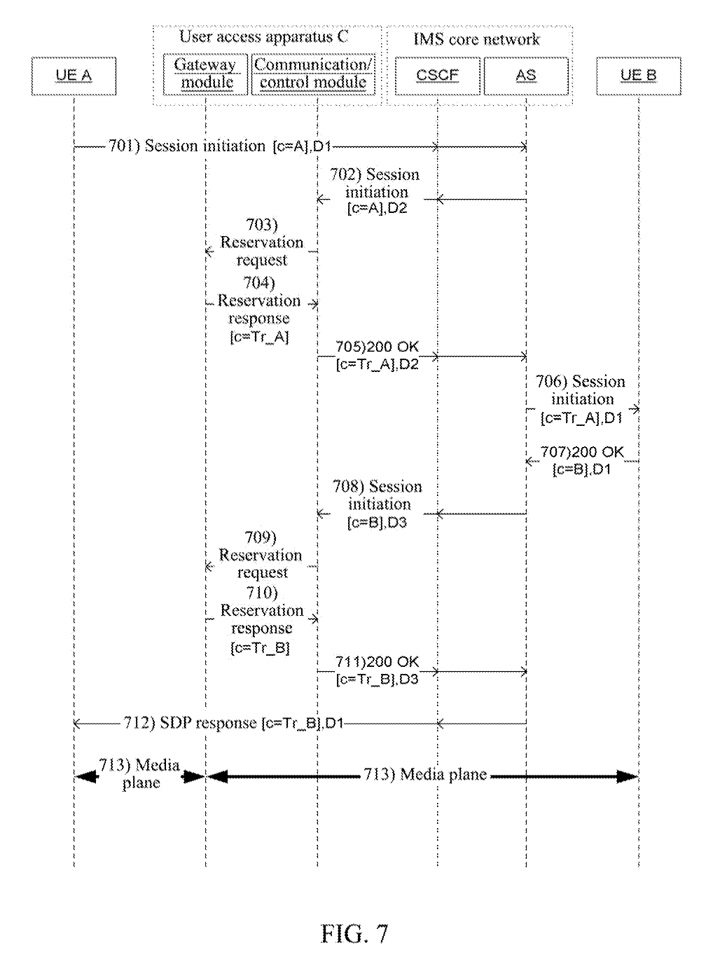

FIG. 7 is a diagram of another session establishment process in accordance with an embodiment the present invention, and the specific process is described as follows.

In step 701, the UE A calls the UE B, and sends a session initiation message (that is, the session request message, usually the INVITE message) to the peer end through the IMS core network, the SIP dialog corresponding to the message is labeled as Dl, and the message carries the SDP provision information, which comprises the media plane contact address c=A of this session, and the message reaches the application server AS after being forwarded by the CSCF.

In step 702, the application server determines that the session needs to be forwarded by the access apparatus C in order to better provide services to the session, therefore, a new session initiation message is initiated, the dialogue identifier corresponding to the message is D2, and the media plane contact address carried in message is the same as the D1, and it is c=A.

In step 703, after the control module in the access apparatus C receives the SDP provision information, it sends a resource reservation request to the gateway module.

In step 704, after the gateway module completes the resource reservation, it returns the resource reservation result c=Tr_A, meanwhile stores the correspondence between the reservation result Tr_A and the original media plane contact address A.

In step 705, the access apparatus C generates a response message (200 OK), wherein, the message carries the reservation resource c=Tr_A, and after the response message is forwarded by the CSCF, it reaches the application server.

In step 706, the application server replaces the media plane contact address information in the dialogue D1 with the information returned in the D2, and sends that information to the peer UE B.

In step 707, the UE B returns the SDP response to the IMS core network, and the response carries the media plane contact address of UE B, that is, c=B.

In step 708, similar to the step 702, the application server generates a new session initiation message and sends it to the selected access gateway C, the message corresponds to the dialogue D3 to require the user access gateway to reserve the resources, herein, the application server might also select another access apparatus, and the access apparatus C is selected in this example only in order to facilitate the description.

In step 709, after the control module in the access apparatus C receives the session initiation request, it sends a resource reservation request to the gateway module.

In step 710, similar to the step 704, after the gateway module completes the resource reservation, it returns the resource reservation result c=Tr_B, and records the correspondence between the Tr_B and the B.

In step 711, the access apparatus C generates the final response message (200 OK), and after putting the reservation result c=Tr_B into the response message, returns the message to the application server.

In step 712, the application server replaces the media plane contact address in the response message of the dialogue Dl with the c=Tr_B returned in the D3, and sends it to the UE A.

In step 713, to this point, the UE A and the UE B complete the SDP negotiation of the session, the media link forwarded through the access apparatus C might be established according to the negotiation result, and the media session may be performed.

In accordance with the RFC protocol, the 3pcc process has a variety of implementations, but the processing procedures and methods of the user access apparatus itself are the same in various implementations, thus they are not described here.

Since the 3pcc processes all need the application server as a third-party to control the session between the two parties, thus in the FIG. 7 where the 3pcc process is used, only the application service is used to execute functions such as the judgment, the resource reservation, the SDP update, and so on.

It can be seen that the apparatus provided in the present invention can establish a secure and trustful mechanism between the apparatus and the IMS core network relying on the existing secure rules of the Gm interface, thus ensuring a secure and reliable communication between the apparatus and the IMS core network, the apparatus is no longer limited to be just deployed in the proprietary networks of the trusted carriers, it can also be deployed to a network location which is closest to the user, thus greatly reducing the difficulty of controlling the quality of the network between the user and the access network.

Of course, the present invention might also have a variety of other embodiments, without departing from the spirit and essence of the present invention, those skilled in the field can make corresponding changes and modifications according to the present invention, and these changes and modifications should belong to the protection scope of the claims appended in the present invention.

### INDUSTRIAL APPLICABILITY

The apparatus provided in the present invention can be deployed flexibly, and the apparatus is not limited to be deployed within the IMS core network, but can be deployed at any location in the network. Moreover, since the apparatus has functions such as registration and cancellation, adding or removing an apparatus does not need to configure other apparatuses within the core network, thereby allowing for relatively frequent adjustment; if the network has multiple of these apparatuses, all of the apparatuses are expected to be opened before the arrival of the peak of the traffic, and part of the apparatuses are shut down after the peak of the traffic, so as to achieve energy saving efficacy.

What is claimed is:

1. A method for user equipment accessing in an internet protocol multimedia subsystem (IMS), comprising:
setting a user equipment access apparatus at user equipment side;
when the user equipment establishes a session with a peer network element through an IMS core network, the IMS core network instructing the user equipment access apparatus to reserve media plane forwarding resource, and the user equipment access apparatus allocating the media plane forwarding resource to the user equipment; and
during a session between the user equipment and the peer network element, said user equipment access apparatus forwarding media plane information between the user equipment and the peer network element according to the media plane forwarding resource.

2. The method of claim 1, wherein,
after the step of setting the user equipment access apparatus at the user equipment side, the method also comprises:
the user equipment access apparatus signing a contract with an IMS operator, registering to the IMS core network, and setting up a trust relationship between the user equipment access apparatus and the IMS core network.

3. The method of claim 2, wherein,
in the step of registering, the user equipment access apparatus informing the IMS core network that the user equipment access apparatus is an access apparatus through apparatus authentication information; or, the user equipment access apparatus informing the IMS core network that the user equipment access apparatus is an access apparatus by adding an identifier and/or writing apparatus ability in a message interacted with the IMS core network.

4. The method of claim 1, wherein,
the step of the IMS core network instructing the user equipment access apparatus to reserve the media plane forwarding resources comprises:
after an application server (AS) in the IMS core network receives a session request message or a session response message sent by the user equipment, the AS judging whether the user equipment access apparatus is needed to perform session transfer or not, if yes, instructing the user equipment access apparatus to reserve the media plane forwarding resources through a call session control function (CSCF);
after the user equipment access apparatus allocates the media plane forwarding resources to the user equipment, the method also comprises:
returning a reservation result to the AS through the CSCF; and
the AS replacing a media plane contact address in the message received from the user equipment according to the reservation result, and forwarding the message to a peer network element through the CSCF.

5. The method of claim 1, wherein,
the step of the IMS core network instructing the user equipment access apparatus to reserve the media plane forwarding resources comprises:
after the CSCF in the IMS core network receives a session request message or a session response message sent by the user equipment, the CSCF judging whether needs the user equipment access apparatus to perform session transfer or not, and if yes, the CSCF instructing the user equipment access apparatus to reserve the media plane forwarding resource;
after the user equipment access apparatus allocates the media plane forwarding resource to the user equipment, the method also comprises:
returning a reservation result back to the CSCF; and
the CSCF replacing the media plane contact address in the message received from the user equipment according to the reservation result, and then forwarding the message to a peer network element through the CSCF.

6. The method of claim 4, wherein,
in the step of instructing, the AS instructing the user equipment access apparatus to reserve the media plane forwarding resources by forwarding the received session request message or session response messages sent by the user equipment to the user equipment access apparatus;
in the step of returning the reservation result, the user equipment access apparatus returning the reservation result to the AS by replacing the media plane contact address in the received session request message or session response message;
or,
in the step of instructing, the AS instructing the user equipment access apparatus to reserve the media plane forwarding resources by newly creating a session request message and sending the session request message to the user equipment access apparatus;
in the step of returning the reservation result, the user equipment access apparatus returning the reservation result back to the IMS core network by returning the session response message to the AS.

7. The method of claim 5, wherein,
in the step of instructing, the CSCF instructing the user equipment access apparatus to reserve the media plane forwarding resources by forwarding the received session request message or session response messages to the user equipment access apparatus;
in the step of returning the reservation result, the user equipment access apparatus returning the reservation result to the CSCF by replacing the media plane contact address in the received session request message or session response message.

8. A user equipment access apparatus in an IP multimedia subsystem, comprising a communication module, a control module and a gateway module, and the apparatus being located at user equipment side, wherein,
the communication module is set to: communicate with an IP multimedia subsystem (IMS) core network, inform the control module when receiving an instruction from the IMS core network for reserving media plane forwarding resource; and send a reservation result returned by the control module to the IMS core network;
said control module is set to: control and manage the communication module and the gateway module, and control the gateway module to allocate media plane forwarding resource when acquiring through the communication module the instruction from the IMS core network for reserving the media plane forwarding resource, receive and return the reservation result sent by the gateway module back to the communication module;
said gateway module is set to allocate the media plane forwarding resource to the user equipment under control of the control module, and inform the control module of the reservation result of the media plane forwarding resource, as well as during a session between the user equipment and a peer network element, forward media plane information between the user equipment and the peer network element according to the media plane forwarding resource.

9. The apparatus of claim 8, wherein,
the control module is also set to register to the IMS core network via the communication module after the user equipment access apparatus signs a contract with an IMS operator, and establish a trust relationship between the user equipment access apparatus and the IMS core network.

10. The apparatus of claim 8, wherein,
the communication module is set to inform the control module after the communication module receives the session request message or the session response messages forwarded by the IMS core network; and send a message returned by the control module to the IMS core network;
said control module is set to control the gateway module to allocate the media plane forwarding resource according to the session request message or the session response message, and, after receiving the reservation result sent by the gateway module, replace a media plane contact address in the received message according to the reservation result, and return the message back to the communication module.

11. The apparatus of claim 8, wherein,
the communication module is set to inform the control module after receiving a session request message newly established by the IMS core network; and, send a session response message returned by the control module to the IMS core network;
said control module is set to control the gateway module to allocate the media plane forwarding resource according to the newly established session request message, and, after receiving the reservation result sent by the gateway module, generate a session response message according to the reservation result, and return to the communication module.
